(19) United States
(12) Patent Application Publication
(10) Pub. No.: US 2005/0001005 A1
(43) Pub. Date: Jan. 6, 2005

(54) Setting tool

(76) Inventors: Harald Fielitz, Lindau (DE); Johann Buechel, Sevelen (CH)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/881,471

(22) Filed: Jun. 30, 2004

(30) Foreign Application Priority Data
Jul. 4, 2003 (DE) 103 30 142.9

(51) Int. Cl. B25C 1/14

(52) U.S. Cl. 227/10

(57) ABSTRACT

A setting tool includes a housing (11), a bolt guide (12) axially displaceable relative to the housing (11), a safety sleeve (20) at least regionwise surrounding the bolt guide (12) and having at least two shell parts (21, 22) formed of tubular sections, and a clamp member (23) at least regionwise encompassing the two shell parts (21, 22) for forming the safety sleeve (20).

### BACKGROUND OF THE INVENTION

1. Field of the Invention

The present invention relates to a setting tool including a housing, a bolt guide axially displaceable relative to the housing, and a safety sleeve at least regionwise surrounding the housing and having at least two shell parts formed of tubular sections.

2. Description of the Prior Art

Setting tools of the type described above can be driven with solid, gaseous, or liquid fuels or with compressed air. In combustion energy-driven tools, the setting or drive piston is driven by high pressure combustion gases. The setting or drive piston drives fastening elements into a constructional component.

For safety reason, in setting tools driven with high-pressure gases, usually, there is provided safety means that prevents actuation of the setting tool when the setting tool is inadvertently pressed against an object. This safety means includes usually a safety sleeve that surrounds the bolt guide and is axially displaceable relative thereto. When the safety sleeve is manually displaced in a direction opposite the setting direction, the safety sleeve prevents actuation of the setting tool.

German Publication DE 100 48 311 A1 discloses a setting tool in which a press-on filler and a protection sleeve surround the bolt guide of the tool. The press-on filler or sleeve and the protection sleeve project beyond the bolt guide in the setting direction and are displaced in a press-on position in which actuation of the setting tool becomes possible, when the setting tool is pressed against a constructional component. When the protection sleeve is manually displaced in the direction opposite the setting direction, the protection sleeve prevents actuation of the setting tool.

The drawback of the setting tool of DE 100 48 311 A1 consists in that the relatively thin bolt guide is subjected to an extreme load when inadvertently several nails are placed upon one another or when the setting tool strikes inadvertently a constructional component.

In a setting tool DX 351 M&E of Hilti Aktiengesellschaft (the assignee herein), catalog, France, 2002, p. 160, a two-part safety sleeve is arranged about the bolt guide, with the bolt guide projecting beyond the safety sleeve in the setting direction. The safety sleeve has two shell parts connected with each other by four threaded elements. The manufacturing of this safety sleeve is rather expensive because of a need in screwing operations in four connecting locations.

Accordingly, an object of the present invention is to provide a setting tool with a safety sleeve in which the drawbacks of the prior art setting tools or safety means are eliminated.

### SUMMARY OF THE INVENTION

This and other objects of the present invention, which will become apparent hereinafter, are achieved according to the present intention of forming the shell parts of tubular sections and by providing a clamp element that at least regionwise surrounds the two shell parts for forming the safety sleeve. The provision of the clamp element saves time during assembly of the safety sleeve as the two shell parts are simply arranged about the bolt guide, and the clamp element is pushed over or is clipped over the two shell parts to connect the two shell parts together. The present invention permits to form the setting tool, in the region of the front end of the bolt guide, very slim, which permits to set fastening elements in very narrow cavities.

Advantageously, the bolt guide is provided at its end facing in the setting direction with a annular cylindrical thickening that protects the safety sleeve from wear. The thickening also increases the service life of the bolt guide. In addition, the thickening prevents the safety sleeve from being lost.

Advantageously, the clamp element is formed as a tubular body the tubular wall of which is provided with a slot extending parallel to the longitudinal axis of the tubular body. The clamp element has, at least in a condition when it surrounds or is pushed over the two shell parts, an outer diameter corresponding to the outer diameter of the cylindrical thickening of the bolt guide. With the outer diameter of the clamp element corresponding to the outer diameter of the bolt guide thickening, the safety sleeve can be flush locked with the front end (annular thickening) of the bolt guide. The slot permits to bend the clamp element off to facilitate its placement on the shell parts.

According to an advantageous embodiment of the present invention, one of the shell parts is provided at one of its end with a projecting element that can be formed as a funnel-shaped element with the funnel opening lying in the direction opposite the setting direction. This element, together with a further transfer member, serve for blocking the actuation switch or a setting process when the setting tool is not pressed against a constructional component and the safety sleeve is manually displaced rearwardly.

It is further advantageous when this projecting element has a recess. In this recess, a complementary projecting element, e.g., a funnel section which is provided on the other of the shell parts, can engage, locking the projecting element of the first shell part. With two projecting elements of which one is provided with a recess, during the assembly of the setting tool, the bolt guide with its thickened front end is pushed through the recess, with subsequent assembly of the shell parts to form the safety sleeve.

The novel features of the present invention, which are considered as characteristic for the invention, are set forth in the appended claims. The invention itself, however both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a side view of a setting tool according to the present invention;

FIG. 2 a longitudinal cross-sectional view along line II-II in FIG. 3 of the bolt guide of the setting tool shown in FIG. 1; and

FIG. 3 an exploded view of the bolt guide of the setting tool shown in FIG. 1.

### DETAILED DESCRIPTION OF THE PREFERRED EMBODIMENTS

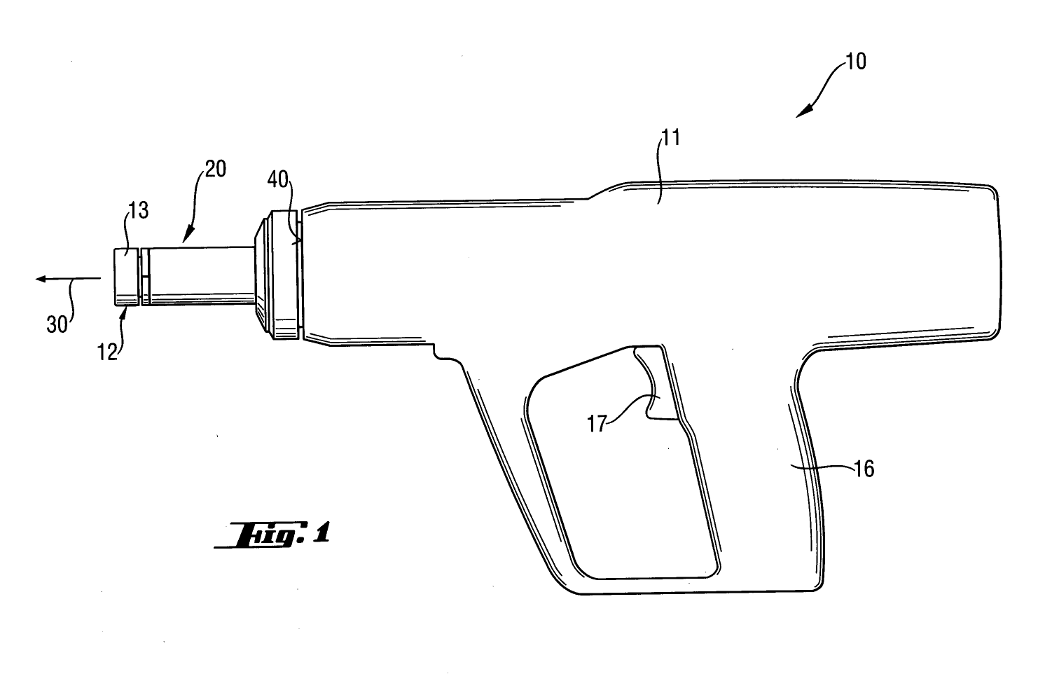

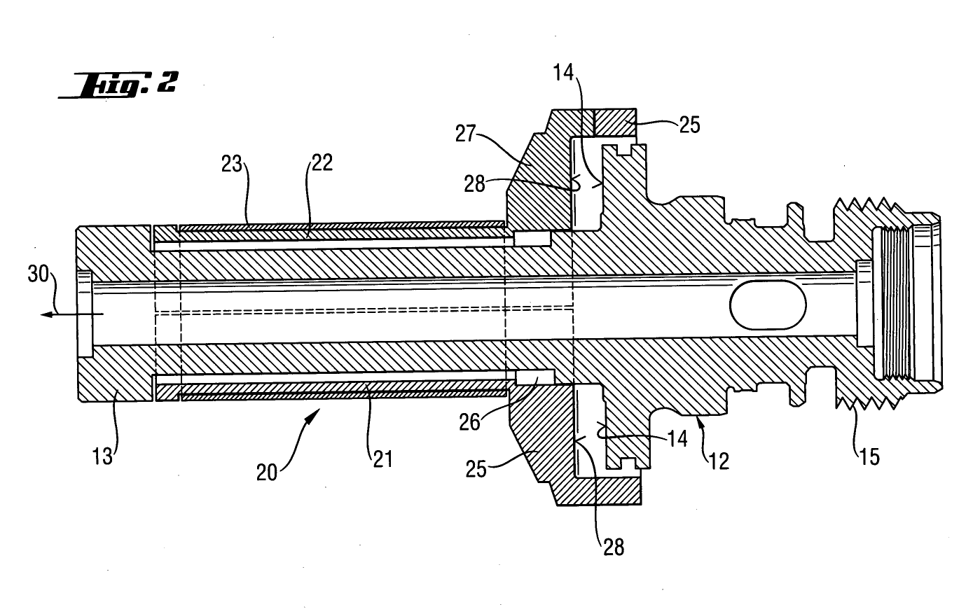

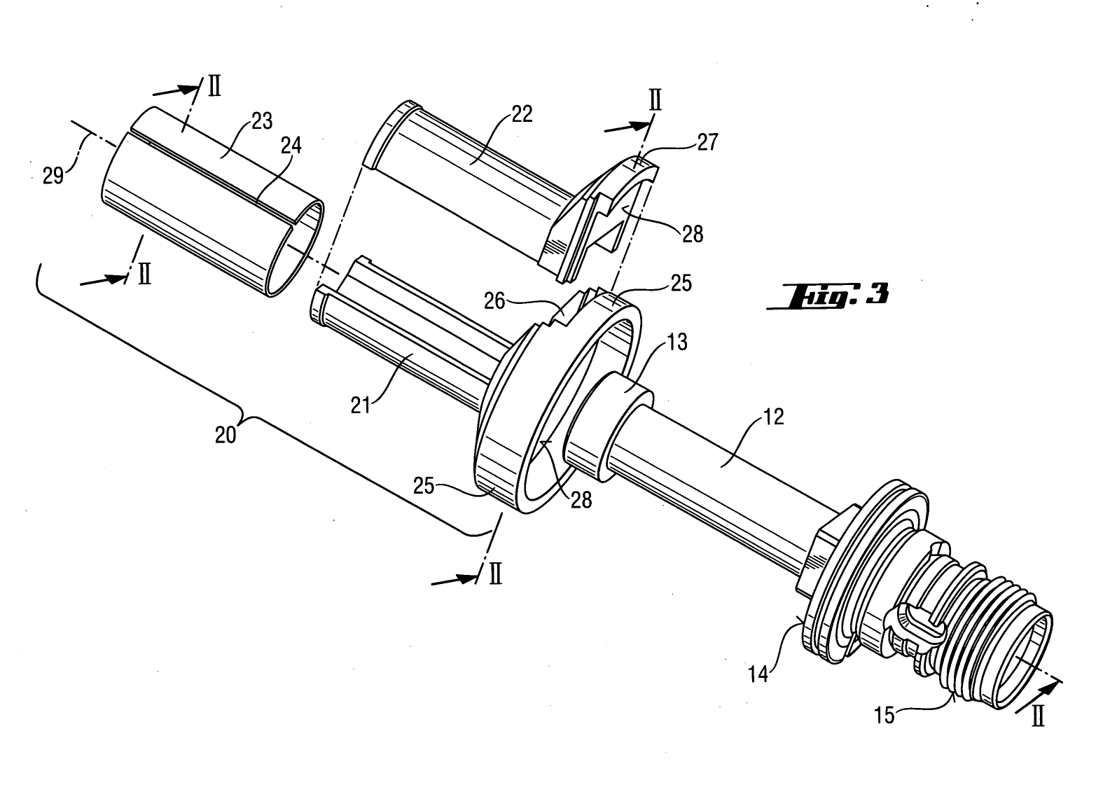

A powder charge-operated setting tool 10 according to the present invention, which is shown in FIGS. 1-3, includes a one-part or multi-part housing 11 in which a piston guide is arranged, and a drive piston (not shown) for fastening elements which is displaceable in the piston guide. For initiating a setting process, an actuation switch 17 is provided on a handle 16 of the setting tool 10. In front of the piston guide, in the setting direction 30 of the setting tool 10, a bolt guide 12 is arranged. The bolt guide 12 is surrounded regionwise by a safety sleeve 20. At the end of the bolt guide 12 adjacent to the piston guide, there is provided connection means 15, such as, e.g., a helical thread, which connects the bolt guide 12 coaxially with the piston guide. At the end of the bolt guide 12 facing in the setting direction 30, there is provided an annular thickening 13 such as, e.g., an annular bead an outer surface of which is flush locked with an outer surface of a clamp element 23, which is formed as an annular body, of the safety sleeve 20. The clamp element 23 has a slot 24 that extends parallel to its longitudinal axis 29 and that insures that the clamp element can be bent off. The safety sleeve 20, which is shown in detail in FIGS. 2-3, has first and second shell parts 21 and 22. Both shell parts 21, 22 are formed, at least regionwise, as a half-shell of a tube and surround the front portion of the bolt guide 12. The thickening 13 of the bolt guide 12 protects the front end of the shell parts 21 and 22 from stripping and other damages. The clamp element 23, which is pushed over the shell parts 21, 22 or is clipped thereover during the assembly of the setting tool 10, connects the two shell parts 21, 22 with each other.

At the rear, in the settling direction 30, end of the first shell part 21, there is provided a funnel-shaped member 25 having a stop surface 28 facing in the direction opposite to the setting direction 30. The member 25 has a recess 26 through which the front end of the bolt guide 12 with the thickening 13 passes during the assembly of the setting tool 10. During the assembly of the setting tool 10, a complementary projecting element 27 of the second shell part 22 is received in the recess 26. In this way, in the assembled condition of the safety sleeve 20, at its end adjacent to the piston guide, there is provided a funnel-shaped element 25, 27 that completely surrounds the bolt guide 12. The recess 26, in which the projecting element 27 of the second shell part 22 is received, provides for correct alignment of the shell part 22. The funnel-shaped element 25, 27 can be engaged with one or more spring elements (not shown) which bias the safety sleeve 20 in the setting direction 30. The bolt guide 12 is provided with a stop 14 which is spaced from the end of the bolt guide 12 facing in the setting direction 30 and is arranged opposite the funnel-shaped element 25, 27. The stop 14 limits the displacement path of the safety sleeve 20 relative to the bolt guide 12. The safety sleeve 20 prevents an inadvertent free running or displacement of the setting tool 10 when the setting tool is not pressed against a constructional component, and only the safety sleeve 20 is pulled manually in the direction opposite the setting direction 30.

The safety sleeve 20 functions as follows. The setting tool 10 is provided with a stop surface 40. When the safety sleeve 20 is unexpectedly pushed in the direction opposite the setting direction 30, the safety sleeve 20 is displaced over the bolt guide 12 in the direction opposite the setting direction 30 until it abuts the stop 14 on the bolt guide 12. Then, with the setting tool 10 being pressed against a constructional component, the safety sleeve 20 is displaced together with the bolt guide 12. A premature actuation of the setting tool 10 is prevented by the fact that the safety sleeve 20 engages the stop surface 40 of the setting tool 10 before the setting tool 10 reaches its ignition position. Further press-on displacement as a result of the safety sleeve 20 being pressed back is not any more possible, which reliably prevents the free running.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

1. A setting tool, comprising a housing (11); a bolt guide (12) axially displaceable relative to the housing (11); and a safety sleeve (20) at least regionwise surrounding the bolt guide (12) and having at least two shell parts (21, 22) formed of tubular sections, and a clamp member (23) at least regionwise encompassing the two shell parts (21, 22) for forming the safety sleeve (20).

2. A setting tool according to claim 1, wherein the bolt guide (12) has, at an end thereof facing in the setting direction (30) of the setting tool, a cylindrical thickening (13) for protecting front ends of the shell parts (21, 22).

3. A setting tool according to claim 1, wherein the clamp element (23) is formed as a tubular body a tubular wall of which is provided with a slot (24) extending parallel to a longitudinal axis (29) thereof.

4. A setting tool according to claim 1, wherein one (21) of the shell parts (21, 22) has at least one outwardly projecting element (25).

5. A setting tool according to claim 4, wherein the projecting element (25) has, viewed in the setting direction 30, a funnel shape.

6. A setting tool according to claim 5, wherein the funnel-shaped element (25) has a recess (26).

7. A setting tool according to claim 6, wherein another (22) of the shell parts (21, 22) has a projecting element (27) complementary to the recess (26) of the funnel-shaped element (25) of the one shell part (21).
